(19) United States
(12) Patent Application Publication
(10) Pub. No.: US 2016/0180317 A1
(43) Pub. Date: Jun. 23, 2016

(54) OFFLINE PEER-TO-PEER TRANSACTIONS

(71) Applicant: Google Inc., Mountain View, CA (US)

(72) Inventors: Narelle Cozens, New York, NY (US); Michael DePasquale, Paris (FR); Travis Harrison Kroll Green, Washington, DC (US); Boris Mizhen, Brooklyn, NY (US); Josh Ostrow, New Rochelle, NY (US); Avery Pennarun, New York, NY (US); Peter Schmitt, Jersey City, NJ (US); Hoai Nguyen, Princeton, NJ (US)

(73) Assignee: Google inc., Mountain View, CA (US)

(21) Appl. No.: 13/794,754

(22) Filed: Mar. 11, 2013

(51) Int. Cl. G06Q 20/22

(52) U.S. Cl. CPC G06Q 20/223

(57) ABSTRACT

Conducting offline transactions comprises associating, using one or more computing devices, a user computing device with a payment account of a user and a counter-party computing device with a payment account of a counter-party, the user computing device and the counter-party computing device being activated to conduct transactions utilizing the accounts; receiving a transaction request from the user computing device indicating that an offline transaction was conducted with the counter-party computing device; conducting a transfer of funds from the payment account of the user to the payment account of the counter-party; providing a confirmation of the transfer to the user computing device and a confirmation of the transfer to the counter-party computing device; and providing an updated balance of the peer-to-peer payment account of the user to the user computing device and an updated balance of the payment account of the counter-party to the counter-party computing device.

### TECHNICAL FIELD

The present disclosure relates generally to peer-to-peer transactions, and more particularly to conducting peer-to-peer transactions with offline user computing devices.

### BACKGROUND

Users of smartphones and other similar devices are conducting an increasing number of electronic transactions. While financial transactions with merchants have become much more user-friendly and commonplace, users are additionally employing their devices to conduct transactions with other mobile device users. These peer-to-peer (“P2P”) transactions allow a user and a counter-party to conduct electronic transactions exclusive of a traditional credit card system or other related system. In addition, an increasing number of small businesses and other merchants will accept a P2P transaction.

Conventional P2P transactions include some risk to the payment recipient, as the payment may not be completed if the payor does not have a funded account, cancels the transaction, has a fraudulent account, or for any other reason does not complete the transaction. A peer-to-peer transaction contains more of a risk than receiving cash from a payor, but may contain similar risks to receiving a check or a credit card payment.

The recipient must trust that a P2P transaction will be conducted, but must also trust that the transaction will be completed in a timely manner. The recipient wants a payment that will be received quickly after the transaction is initiated. In conventional P2P transactions, the devices of the user and the counter-party contact the P2P payment system over a network, and the transaction can be confirmed or conducted in real-time. The payor can confirm that the transaction amount has been transferred from the payor account and that the amount has been transferred to the account of the counter-party. The counter-party can receive confirmation of the completion of the transaction and be assured that the transaction was successful.

Unfortunately, in some P2P transactions, the user and the counter-party may be unable to achieve network access to confirm the transaction. For example, the transaction may be conducted at a location that is outside of the reach of the network, such as outside of the cell coverage of a cellphone network, in a basement, or during a network outage. Thus, the devices of the user and/or the counter-party are unable to communicate with the P2P payment system. In a conventional P2P payment without communication, the user device is unable to transmit the transaction request to the P2P payment system, and the transaction will not be conducted at the accounts of the user and the counter-party.

### SUMMARY

Techniques herein provide a computer-implemented method to conduct offline transactions. A payment system employs a server configured for associating, using one or more computing devices, a user computing device with a payment account of a user and a counter-party computing device with a payment account of a counter-party, the user computing device and the counter-party computing device being activated to conduct transactions utilizing the accounts; receiving a transaction request from the user computing device indicating that an offline transaction was conducted with the counter-party computing device; conducting a transfer of funds from the payment account of the user to the payment account of the counter-party; providing a confirmation of the transfer to the user computing device and a confirmation of the transfer to the counter-party computing device; and providing an updated balance of the peer-to-peer payment account of the user to the user computing device and an updated balance of the payment account of the counter-party to the counter-party computing device.

Another aspect of the example embodiments described herein provides a computer-implemented method to conduct offline transactions. A recipient computing device is configured for receiving a request to transfer money to a payment account of a recipient from a payment account of a payor, the request being received from a payor computing device associated with the payor, wherein the payment account of the recipient is hosted by a payment system, and a recipient computing device associated with the recipient being activated to conduct financial transactions using the payment account of the recipient; determine that communication with the payment system is unavailable; presenting a request to the recipient to accept an offline pending transaction in response to determining that the communication with the payment system is unavailable; receive an input of an acceptance of the request to accept the offline pending transaction; communicating a notice of the acceptance of the offline pending transaction to the payor computing device; determining that communication with the payment system is available; providing transaction details to the payment system in response to determining that communication with the payment system is available; and receiving updated account information for the payment account of the user from the payment system based on the transaction details.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for conducting offline peer-to-peer transactions, in accordance with certain example embodiments.

FIG. 2 is a block flow diagram depicting a method for conducting offline peer-to-peer transactions, in accordance with certain example embodiments.

FIG. 3 is a block flow diagram depicting a method for conducting offline peer-to-peer transactions with a reserve fund, in accordance with certain example embodiments.

FIG. 4 is a block flow diagram depicting a computing machine and a module, in accordance with certain example embodiments.

### DETAILED DESCRIPTION OF THE EXAMPLE EMBODIMENTS

### Overview

The example embodiments provide a peer-to-peer (“P2P”) system for conducting transactions between a user device and a counter-party device. The devices can host P2P payment applications that can allow the devices to communicate directly with each other and with the P2P payment system to allow transfers of money from the account of the user to the account of the counter-party. The counter-party may be another person using the P2P payment system or the counter-party may be a business or other entity.

In an example embodiment, the user accesses the P2P payment application on the user device and the user device communicates with a P2P payment application on a counter-party device. The devices can communicate through any suitable communication technology. For example, the devices can communicate wirelessly via near field communication (“NFC”), Bluetooth, Wi-Fi, infrared, or any other suitable wireless technology. The communication can be initiated by actuating any real or virtual buttons on one or both of the devices, by a voice command, by “tapping” the devices, or any other suitable indication of a request to open a communication.

The user can indicate a desire to transfer money to the counter-party. For example, the user can input the account or other identifier of the counter-party and an amount of money to transfer into the P2P payment application. In an alternate example, the user device can open a dialog box, wizard, website, or other user interface to assist with inputting the transaction and counter-party details. In an alternate example, the P2P payment application can recognize the counter-party device and populate the transaction details for the user.

The P2P payment application of the user can attempt the transaction. The P2P payment application on the user device can transmit the details of the transaction to the P2P payment application on the counter-party device. The counter-party P2P payment application can wait for a confirmation of the details or the counter-party P2P payment application can proceed with the transaction. The user P2P payment application attempts to contact the P2P payment system server to conduct the transaction and transfer the money to the account of the counter-party from the account of the user on the P2P payment system.

In certain instances, the user device may be unable to contact the P2P payment system for any of a number of suitable reasons. For example, the user device may be outside of the coverage area of the service provider of the user device. The user device may be in a location that blocks the network coverage of the user device, such as a basement or other enclosed building. The service provider of the user device may be down due to a failure, for routine maintenance, or for any other reason.

If the user device is unable to contact the P2P payment system, then the transaction will not be completed until coverage is re-established. The counter-party may be unwilling to accept a transaction that is not confirmed or completed before the user and the counter-party depart from one another. For example, if a user is making a purchase from a counter-party, the counter-party may refuse to allow the user to leave with a purchased item without a confirmed transaction.

If the user device is unable to contact the P2P payment system then the user device can request that the counter-party accept the pending offline transaction. For example, the user and the counter-party may have conducted previous transactions, have a personal history together, or for any other reason have a level of trust that the user will be able to complete the transaction. The counter-party can indicate on the P2P payment application that the offline transaction is accepted.

Additionally or alternatively, the P2P payment application on the counter-party device can be configured to always accept transactions from the P2P payment application on the user device. If the P2P payment application is configured to accept all transactions from the user, then the P2P payment application on the counter-party device can accept the offline transaction, whether network access is available or not.

If the offline transaction is accepted without network access, and therefore without confirmation from the P2P payment system that the transaction is conducted, then the P2P payment applications on the user device and the counter-party device can indicate that the transaction is a pending transaction. Alternatively, the P2P payment applications on the user device and the counter-party device can indicate that the transactions are conducted despite not receiving confirmation from the P2P payment system. The P2P payment applications may be configured to not allow funds received from a pending transaction to be spent in a future transaction until confirmation is received from the P2P payment system and the account of the counter-party on the P2P payment system is updated.

If the counter-party P2P payment application is not configured to accept offline transactions, or if the counter-party does not input an acceptance of the offline transaction, then the transaction can be refused by the P2P payment application of the counter-party.

In an alternate embodiment, a P2P payment account of a user on a P2P payment system can establish a reserve fund. The funds in the reserve fund account can be used as a guarantee that funds are available for an offline transaction. In an example, a user can establish a reserve fund of $100. The P2P payment application can be configured to confirm any offline transactions up to $100. That is, a user can make a payment with the P2P payment application without network access and the transaction can be shown as confirmed. The P2P payment application can log multiple offline payments and confirm the transactions until the $100 limit is reached by the multiple transactions. Further transactions would not be shown as confirmed.

In an example embodiment, the reserve account can only be associated with one user device. If the reserve account were associated with two devices that are both out of network contact with the P2P payment system, the user might conduct transactions up to the reserve account limit with each user device. Thus, the transaction totals would exceed the guaranteed reserve funds available and the transactions would not be guaranteed by the P2P payment system.

In the example embodiment, if the user conducts P2P payments with two devices, the P2P payment system requires that the user designate a particular one of the user devices to be associated with the reserve account. For example, the user can establish two reserve accounts and associate one reserve account with each of the user devices. In another example, the user can divide the reserve account funds between multiple user devices and assign a designated amount to be associated with each user device. The user may associate reserve funds with a particular user device in any other suitable manner.

The P2P payment application on the counter-party device can receive the reserve funds and indicate that the funds are confirmed from the user device. If the counter-party device has network access then the P2P payment application can communicate with the P2P payment system and the transfer will be verified and the account of the counter-party will indicate the transaction is complete. If the counter-party device does not have network access, then the counter-party P2P payment application can indicate that the funds are confirmed, and the balance of the counter-party P2P payment account on the counter-party device may show the transaction as completed. The counter-party account on the P2P payment system is not updated until the counter-party device achieves network access and can again communicate with the P2P payment system. In an example embodiment, the transaction can show as confirmed and the balances can be updated on the P2P payment application, but the funds may be unavailable for spending until the P2P payment system is able to contact the user device and the counter-party device and the transaction is confirmed.

After the offline transaction is conducted between the user device and the counter-party device, the devices regain network connectivity at a later time. For example, the devices may re-enter the cell coverage area of a network, the network may be brought back online, or the obstructions of the devices, such as the walls of a basement, may be removed.

After regaining network connectivity, the P2P payment applications on the user device and the counter-party device can communicate with the P2P payment system. The P2P payment applications can provide the P2P payment system with the details of the transaction. The P2P payment system can access the accounts of the user and the counter-party on the P2P payment system and conduct the transfer of funds. The accounts of the user and the counter-party are updated to reflect the transfer.

In an example embodiment, the transaction can be conducted and recorded on the P2P payment system after receiving the transaction details from either, or both, of the P2P payment applications. That is, if either the P2P payment application on the user device or the P2P payment application on the counter-party device regain network connectivity and provide the transaction details, then the P2P payment system can conduct the transaction.

The P2P payment system can transmit a confirmation of the transaction to the P2P payment applications on the user device and the counter-party device. The P2P payment applications can indicate the updated user balances to reflect the confirmed transfer. In a transaction history user interface, the P2P payment applications can additionally indicate that the transaction has been conducted and confirmed.

### Example System Architectures

Turning now to the drawings, in which like numerals represent like (but not necessarily identical) elements throughout the figures, example embodiments are described in detail.

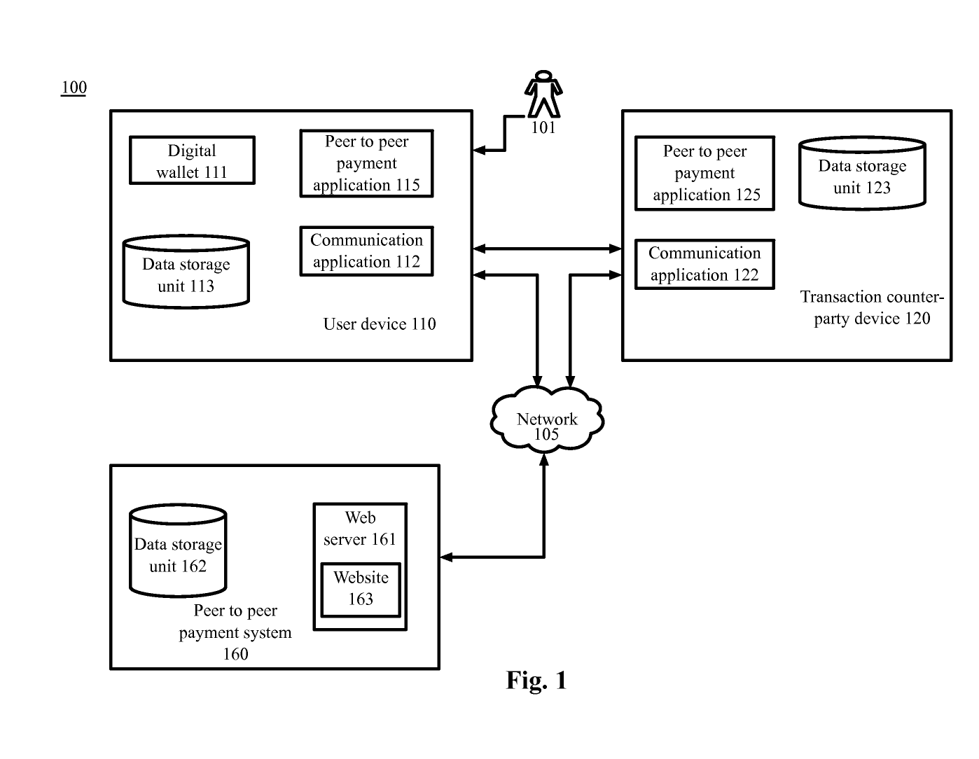

FIG. 1 is a block diagram depicting a system for conducting offline peer-to-peer transactions, in accordance with certain example embodiments. As depicted in FIG. 1, the system 100 includes network devices 110, 120, and 160 that are configured to communicate with one another via one or more networks 105.

Each network 105 includes a wired or wireless telecommunication means by which network devices (including devices 110, 120, and 160) can exchange data. For example, each network 105 can include a local area network (“LAN”), a wide area network (“WAN”), an intranet, an Internet, a mobile telephone network, or any combination thereof. Throughout the discussion of example embodiments, it should be understood that the terms “data” and “information” are used interchangeably herein to refer to text, images, audio, video, or any other form of information that can exist in a computer-based environment.

Each network device 110, 120, and 160 includes a device having a communication module capable of transmitting and receiving data over the network 105. For example, each network device 110, 120, and 160 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110, 120 and 160 are operated by end-users or consumers on user devices, transaction counter-parties, and peer-to-peer (“P2P”) processing system operators respectively.

The user 101 can use the communication application 112 on a user mobile device 110, such as a web browser application or a stand-alone application, to view, download, upload, or otherwise access documents or web pages via a distributed network 105. The network 105 includes a wired or wireless telecommunication system or device by which network devices (including devices 110, 120, and 160) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages.

The communication application 112 can interact with web servers or other computing devices connected to the network 105, including transaction counter-party devices 120 and the web server 161 of the P2P processing system 140.

The user mobile device 110 may include a digital wallet application module 111. The digital wallet application module 111 can encompass any application, hardware, software, or process the user devices 110 can employ to assist the user 101 in completing a purchase. A digital wallet application module 111 can interact with a communication application 112 or can be embodied as a companion application of the communication application 112. As a companion application, a digital wallet application module 111 executes within a communication application 112. That is, a digital wallet application module 111 may be an application program embedded in a communication application 112.

The user device 110 may include a P2P payment application 115. The P2P payment application 115 can interact with the communication application 112 or be embodied as a companion application of the communication application 112 and execute within the communication application 112. The P2P payment application 115 may further be embodied as a companion application of the digital wallet application module 111 and execute within the digital wallet application module 111. The P2P payment application 115 may employ a software interface that may open in the digital wallet module application 111 or may open in the communication application 112. The interface can allow the user 101 to configure the P2P payment application 115 and the user account on the P2P payment system 160.

The P2P payment application 115 can be used to send transaction requests to the P2P payment system 160 and receive an authorization request from the P2P payment system 160. The P2P payment system 160 that develops authorization requirement and prosecutes the transaction can include a set of computer-readable program instructions, for example, using JavaScript, that enable the P2P payment system 160 to interact with the P2P payment application 115.

The user mobile device 110 also includes a data storage unit 113 accessible by the digital wallet application module 111 and the communication application 112. The example data storage unit 113 can include one or more tangible computer-readable storage devices. The data storage unit 113 can be stored on the user mobile device 110 or can be logically coupled to the user mobile device 110. For example, the data storage unit 113 can include on-board flash memory and/or one or more removable memory cards or removable flash memory.

The user 101 may use the user device 110 or other user computing device to register the digital wallet application module 111, or a digital wallet account and/or to access the digital wallet account of the user 101. The user mobile device 110 may comprise appropriate technology that includes or is coupled to a web server (for example, a web browser application, or other suitable application for interacting with web page files).

The P2P payment system 160 utilizes a web server 161. The P2P payment system server 161 may represent the computer implemented system that the P2P payment system 160 employs to configure user accounts, create and maintain user profiles, and conduct transactions. The P2P payment system website 163 may represent any web-based interface that allows users to interact with the P2P payment system 160 to configure the user accounts and change account settings. The web server 161 can communicate with one or more transaction counter-party devices 120 and a user device 110 via any available technologies. These technologies may include, but would not be limited to, an Internet connection via the network 105, email, text, instant messaging, or other suitable communication technologies. The P2P payment system 160 may include a data storage unit 162 accessible by the web server 161 of the P2P payment system 160. The data storage unit 162 can include one or more tangible computer-readable storage devices.

In alternate embodiments, some or all of the functions or actions of the P2P payment system 160 may be performed by the user device 110 or executed on the user device 110.

The transaction counter-party device 120 may represent the devices with which the user 101 may conduct a peer-to-peer transaction. Like the user device 110, the transaction counter-party device 120 may be a mobile device, (for example, notebook computer, tablet computer, netbook computer, personal digital assistant (PDA), video game device, GPS locator device, cellular telephone, smartphone, or other mobile device), personal computer, or other appropriate technology that includes or is coupled to a web browser application module 112.

The transaction counter-party device 120 may include a P2P payment application 125, a counterpart to P2P payment application 115, or a compatible transaction application that will allow transactions with the user device 110. The transaction counter-party device 120 may include a communication application 122. The counter-party can use the communication application 122, such as a web browser application or a stand-alone application, to view, download, upload, or otherwise access documents or web pages via a distributed network 105.

### Example Processes

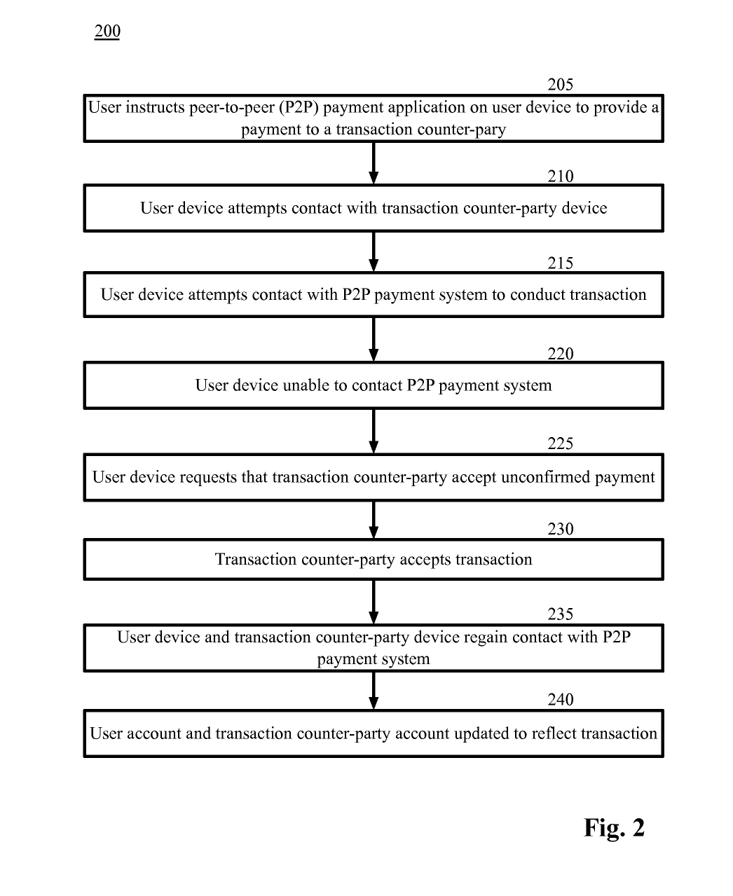

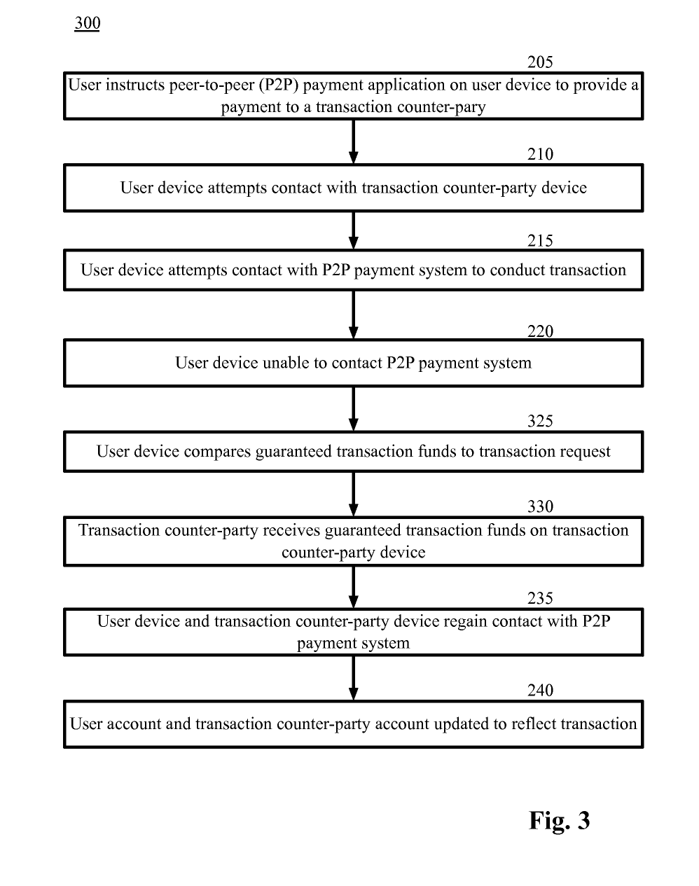

The components of the example operating environment 100 are described hereinafter with reference to the example methods illustrated in FIGS. 2-3.

FIG. 2 is a block flow diagram depicting a method 200 for conducting offline peer-to-peer (“P2P”) transactions, in accordance with certain example embodiments.

In block 205, the user 101 accesses the P2P payment application 115 on the user device 110 and communicates with a P2P payment application 125 on a counter-party device 120. The devices 110, 120 can communicate through any suitable communication technology. For example, the devices 110, 120 can communicate wirelessly via near field communication (“NFC”), Bluetooth, Wi-Fi, infrared, or any other suitable wireless technology. The communication can be initiated by actuating any real or virtual buttons on one or both of the devices 110, 120, by a voice command, by “tapping” the devices, or any other suitable indication of a request to open a communication.

The user 101 can indicate a desire to transfer money to the counter-party. For example, the user 101 can input the account or other identifier of the counter-party and an amount of money to transfer. In an alternate embodiment, the user device 110 can open a dialog box, wizard, website, or other user interface to assist with inputting the transaction and counter-party details. In an alternate example, the P2P payment application 115 can recognize the counter-party device 120 and populate the transaction details for the user 101.

In block 210, the P2P payment application 115 of the user 101 initiates the transaction by transmitting the details of the proposed transaction to the P2P payment application 125 on the counter-party device 120. The counter-party P2P payment application 125 can wait for a confirmation of the transfer from the P2P payment system 160 or the counter-party P2P payment application 125 can proceed with recording the transaction.

In block 215, the user P2P payment application 115 attempts to contact the P2P payment system server 161 to request the transaction and transfer the money to the account of the counter-party from the account of the user 101 on the P2P payment system 160. The user device 110 and the counter-party device 120 can communicate with the P2P payment system 160 via any available technology, such as via the Internet over the network 105, text, email, instant message, or in any other suitable manner.

In block 220, the user device 110 may be unable to contact the P2P payment system 160 for any suitable reason. For example, the user device 110 may be outside of the coverage area of the service provider of the user device 110. The user device 110 may be in a location that blocks the network coverage of the user device 110, such as a basement or other enclosed building. The service provider of the user device 110 may be down due to a failure, for routine maintenance, or for any other reason.

If the user device 110 is unable to contact the P2P payment system 160, then the transaction will not be completed until coverage is re-established. The counter-party may be unwilling to accept a transaction that is not confirmed or completed before the user 110 and the counter-party depart from one another. For example, if a user 101 is making a purchase from a counter-party, the counter-party may refuse to allow the user 101 to leave with a purchased item without a confirmed transaction.

In block 225, if the user device 110 is unable to contact the P2P payment system 160, then the user device 110 can request that the counter-party accept the pending offline transaction. The request can be a communication between the user device 110 and the transaction counter-party device 120.

In block 230, the P2P payment application 125 on the counter-party device 120 accepts the request for an offline transaction. In an example embodiment, the P2P payment application 125 on the counter-party device 120 logs the acceptance of the offline transaction and also communicates a notification to the P2P payment application 115 on the user device 110 for the P2P payment application 115 to log the accepted offline transaction.

The request can be presented to the counter-party for the counter-party to input a decision or the request can be accepted or rejected based on a set of configured rules or other automatic responses. For example, the counter-party P2P payment application 125 may be configured to refuse all requests for offline transactions. In another example, the counter-party P2P payment application 125 may be configured to accept only requests for offline transactions from payors listed on a preferred counter-party list. In example embodiments, the user 101 and the counter-party may have conducted previous transactions, have a personal history together, or for any other reason have a level of trust that the user 101 will be able to complete the transaction. The counter-party may manually accept the request based on these inputs, or the counter-party device 120 may be configured to accept the request of the user 101 meets the preconfigured conditions based on the established trust level. The counter-party can indicate on the P2P payment application 125 that the offline transaction is accepted and the acceptance can be transmitted to the user device 110. Any other suitable set of rules or restrictions may be employed.

Additionally or alternatively, the P2P payment application 125 on the counter-party device 120 can be configured to always accept transactions from the P2P payment application 115 on the user device 110. If the counter-party P2P payment application 125 is configured to accept all transactions from the P2P payment application 115, then the P2P payment application 125 on the counter-party device 120 can accept the offline transaction, whether network access is available or not.

If the offline transaction is accepted without network access, and therefore without confirmation from the P2P payment system 160 that the transaction is conducted, then the user device 110 and the counter-party device 120 can indicate that the transaction is a pending transaction. Alternatively, the P2P payment applications 115, 125 on the user device 110 and the counter-party device 120 can indicate that the transactions are conducted despite not receiving confirmation from the P2P payment system 160. The P2P payment applications 115, 125 may be configured to not allow funds received from a pending transaction to be spent in a future transaction until confirmation is received from the P2P payment system 160 and the account of the counter-party on the P2P payment system 160 is updated.

If the counter-party P2P payment application 125 is not configured to accept offline transactions, or if the counter-party does not input an acceptance of the offline transaction, then the transaction can be refused by the P2P payment application 125 of the counter-party.

In block 235, after the offline transaction is conducted between the user device 110 and the counter-party device 120, the devices 110, 120 regain network connectivity at a later time. For example, the devices 110, 120 may re-enter the cell coverage area of a network, the network may be brought back online, or the devices 110, 120 may be removed from behind the obstructions.

After regaining network connectivity, the P2P payment applications 115, 125 on the user device 110 and the counter-party device 120 can communicate with the P2P payment system 160. The P2P payment applications 115, 125 can provide the P2P payment system 160 with the details of the transaction. The P2P payment system 160 can access the accounts of the user 101 and the counter-party on the P2P payment system 160 and conduct the transfer of funds.

In an example embodiment, the transaction can be conducted and recorded on the P2P payment system 160 after receiving the transaction details from either, or both, of the P2P payment applications 115, 125. That is, if either the P2P payment application 115 on the user device 110 or the P2P payment application 125 on the counter-party device 120 regain network connectivity and provide the transaction details, then the P2P payment system 160 can conduct the transaction.

In block 240, P2P payment system 160 updates the accounts of the user 101 and the counter-party on the P2P payment system 160 to reflect the transfer. The account balances and account histories on the P2P payment applications 115, 125 also are updated. For example, the P2P payment system 160 can communicate the updated account information to the corresponding P2P payment applications 115, 125 on the user device 110 and counter-party device 120. The balances and histories can indicate that the balances and histories are confirmed and updated as of a particular time and date. For example, at the last communication of the P2P payment system 160 and the P2P payment applications 115, 125, the P2P payment applications 115, 125 can record a time stamp of the time of the update and display the time stamp along with a confirmed account balance and history.

FIG. 3 is a block flow diagram depicting a method 300 for conducting offline P2P transactions with a reserve fund, in accordance with certain example embodiments.

Block 205 to block 220 in method 300 of FIG. 3 are substantially the same as block 205 to block 220 in method 200 of FIG. 2.

In block 325, the P2P payment application 115 compares the transaction amount with a reserve account of the user 101. The P2P payment application 115 of the user 101 on a P2P payment system 160 can establish a reserve fund. The funds in the reserve fund account can be used as a guarantee that funds are available for an offline transaction. For example, a user 101 can establish a reserve fund of $100 in the user's account on the P2P payment system 160. The P2P payment application 115 can be configured to confirm any offline transactions up to $100. That is, a user 101 can make a payment with the P2P payment application 115 without network access, and the transaction can be shown as confirmed, if that transaction does not exceed the amount of the reserve fund. The P2P payment application 115 can log multiple offline payments and confirm the transactions until the reserve fund limit is reached by the multiple transactions. Further transactions would not be shown as confirmed.

In an example embodiment, the P2P payment system 160 will not allow a user to remove funds from the reserve account unless the P2P payment application 115 is in contact with the P2P payment system 160. For example, if a user 101 attempts to remove funds from the reserve account, the removal does not take place until the P2P payment application 115 on the user device 110 is updated as well. In this example, a P2P payment application 115 will never display an amount of funds in the reserve account that is greater than the funds that are in the reserve account. Thus, when the P2P payment application 115 transmits a guaranteed payment, the funds will always be available.

In an example embodiment, the reserve fund can only be associated with one user device 110. If the reserve account were associated with two user devices 110 that are both out of network contact with the P2P payment system 160, the user might conduct transactions up to the reserve account limit with each user device 110. Thus, the transaction totals would exceed the guaranteed reserve funds available and the transactions would not be guaranteed by the P2P payment system 160.

In the example embodiment, if the user 101 conducts P2P payments with two user devices 110, the P2P payment system 160 requires that the user designate a particular one of the user devices 110 to be associated with the reserve account. For example, the user 101 can establish two reserve accounts and associate one reserve account with each of the user devices 101. In another example, the user 101 can divide the reserve account funds between multiple user devices 110 and assign a designated amount to be associated with each user device 110. The user 101 may associate reserve funds with a particular user device 110 in any other suitable manner.

In block 330, the P2P payment application 125 on the counter-party device 120 can receive the reserve funds and indicate to the counter-party that the funds are confirmed from the user device 110. If the counter-party device 120 has network access, then the P2P payment application 125 can communicate with the P2P payment system 160 and the transfer will be verified and the account of the counter-party will indicate the transaction is complete. If the counter-party device 120 does not have network access, then the counter-party P2P payment application 125 can indicate that the funds are confirmed, and the balance of the counter-party P2P payment application 125 on the counter-party device 120 may show the transaction as completed. The counter-party account on the P2P payment system 160 is not updated until the counter-party device achieves network access and can again communicate with the P2P payment system.

Block 235 and block 240 in method 300 of FIG. 3 are substantially the same as bloc 235 and block 240 in method 200 of FIG. 2.

### Example Systems

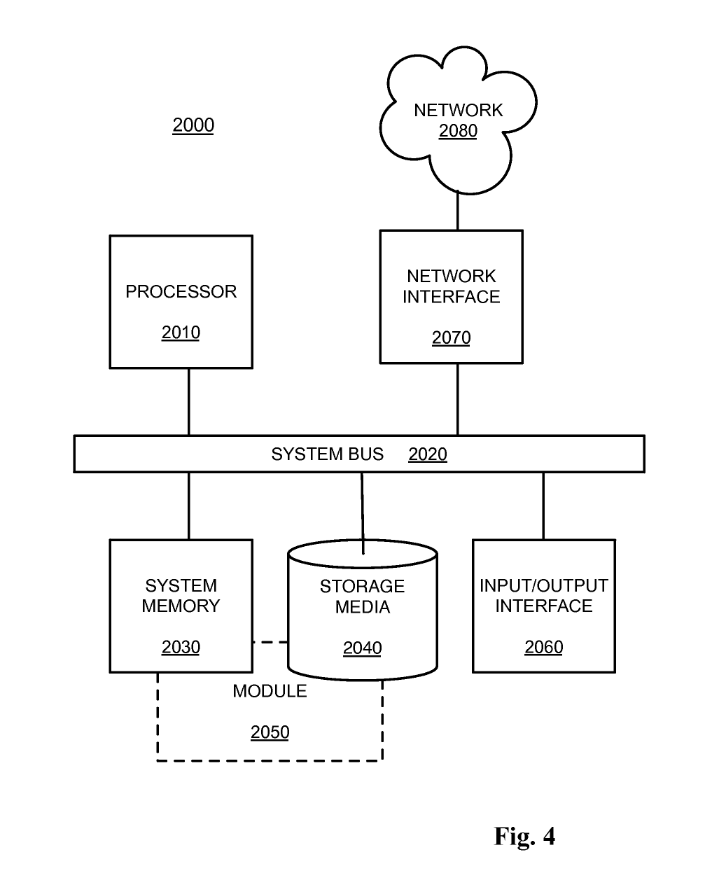

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to conduct offline transactions, comprising:
associating, using one or more computing devices, a user computing device with a payment account of a user that is hosted by the one or more computing devices and a counter-party computing device with a payment account of a counter-party that is hosted by the one or more computing devices, the user computing device and the counter-party computing device being activated to conduct transactions utilizing the payment account of the user and the payment account of the counter-party that are hosted by the one or more computing devices;
receiving, using the one or more computing devices, a transaction request from the counter-party computing device indicating that an offline transaction was conducted between the counter-party computing device and the user computing device;
recording, using the one or more computing devices, the transaction as a pending transaction in the payment account of the user;
receiving, using the one or more computing devices, a transaction request from the user computing device indicating that the offline transaction was conducted between the counter-party computing device and the user computing device;
based upon receiving the transaction request from the user computing device, removing, using the one or more computing devices, the pending status from the transaction in the payment account of the user;
conducting, using the one or more computing devices, a transfer of funds from the payment account of the user to the payment account of the counter-party;
providing, using the one or more computing devices, a confirmation of the transfer to the user computing device and a confirmation of the transfer to the counter-party computing device; and
providing, using the one or more computing devices, an updated balance of the payment account of the user to the user computing device and an updated balance of the peer-to-peer payment account of the counter-party to the counter-party computing device.

2. The computer-implemented method of claim 1, wherein the offline transaction is conducted between applications operating on the user computing device and the counter-party device.

3. The computer-implemented method of claim 1, wherein the transaction is indicated as a pending transaction on the user computing device and the counter-party device.

4. The computer-implemented method of claim 1, further comprising:
establishing, using the one or more computing devices, a reserve fund account of the user; and
providing, using the one or more computing devices, instructions to the user computing device to provide confirmation of a transaction limited to the amount of funds in the reserve fund account.

5. The computer-implemented method of claim 4, wherein an amount of funds in the established reserve fund can only be changed when the one or more computing devices is in communication with the user computing device.

6. (canceled)

7. The computer-implemented method of claim 1, wherein funds associated with the pending transaction are not available for further transactions until the one or more computing devices receives the transaction request from the user computing device.

8. (canceled)

9. (canceled)

10. (canceled)

11. (canceled)

12. A computer program product, comprising:
a non-transitory computer-readable storage device having computer-readable program instructions embodied thereon that when executed by a computer causes the computer to conduct offline transactions, the computer-readable program instructions comprising:
computer-readable program instructions to associate a user computing device with a payment account of a user that is hosted by the computer and a counter-party computing device with a payment account of a counter-party that is hosted by the computer, the user computing device and the counter-party device being activated to conduct transactions utilizing the payment account of the user and the payment account of the counter-party that are hosted by the computer;
computer-readable program instructions to receive a transaction request from the counter-party computing device indicating that an offline transaction was conducted between the counter-party computing device and the user computing device;
computer-readable program instructions to record the transaction as a pending transaction in the payment account of the user, wherein funds associated with the pending transaction are not available for further transactions until the non-transitory computer-readable storage device receives the transaction request from the user computing device;
computer-readable program instructions to receive a transaction request from the user computing device that an offline transaction was conducted with the counter-party computing device;
computer-readable program instructions to remove the pending status from the transaction in the payment account of the user based upon receiving the transaction request from the user computing device;
computer-readable program instructions to conduct a transfer of funds from the payment account of the user to the payment account of the counter-party;
computer-readable program instructions to provide a confirmation of the transfer to the user computing device and a confirmation of the transfer to the counter-party computing device; and
computer-readable program instructions to provide an updated balance of the peer-to-peer payment account of the user to the user computing device and an updated balance of the payment account of the counter-party to the counter-party computing device.

13. The computer program product of claim 12, wherein the offline transaction is conducted between applications operating on the user computing device and the counter-party device.

14. The computer program product of claim 12, wherein the transaction is indicated as a pending transaction on the user computing device and the counter-party device.

15. The computer program product of claim 12, further comprising:
computer-readable program instructions to establish a reserve fund account of the user; and
computer-readable program instructions to provide instructions to the user computing device to provide confirmation of a transaction limited to the amount of funds in the reserve fund account.

16. (canceled)

17. (canceled)

18. (canceled)

19. (canceled)

20. (canceled)

21. (canceled)

22. A system to conduct offline transactions, comprising:
a storage device;
a network device; and
a processor communicatively coupled to the storage device and the network device, wherein the processor executes application code instructions that are stored in the storage device to cause the system to:
associate a user computing device with a payment account of a user that is hosted by the processor and a counter-party computing device with a payment account of a counter-party that is hosted by the processor, the user computing device and the counter-party device being activated to conduct transactions utilizing the payment account of the user and the payment account of the counter-party that are hosted by the processor;
receive a transaction request from the counter-party computing device indicating that an offline transaction was conducted between the counter-party computing device and the user computing device;
record the transaction as a pending transaction in the payment account of the user, wherein funds associated with the pending transaction are not available for further transactions until the non-transitory computer-readable storage device receives the transaction request from the user computing device;
receive a transaction request from the user computing device that an offline transaction was conducted with the counter-party computing device;
remove the pending status from the transaction in the payment account of the user based upon receiving the transaction request from the user computing device;
conduct a transfer of funds from the payment account of the user to the payment account of the counter-party;
provide a confirmation of the transfer to the user computing device and a confirmation of the transfer to the counter-party computing device; and
provide an updated balance of the peer-to-peer payment account of the user to the user computing device and an updated balance of the payment account of the counter-party to the counter-party computing device.

23. The system of claim 22, wherein the offline transaction is conducted between applications operating on the user computing device and the counter-party device.

24. The system of claim 22, wherein the transaction is indicated as a pending transaction on the user computing device and the counter-party device.

25. The system of claim 22, wherein an amount of funds in the established reserve fund can only be changed when the one or more computing devices is in communication with the user computing device.

26. The system of claim 22, wherein funds associated with the pending transaction are not available for further transactions until the one or more computing devices receive the transaction request from the user computing device.

27. The computer program product of claim 12, wherein an amount of funds in the established reserve fund can only be changed when the one or more computing devices is in communication with the user computing device.

28. The computer program product of claim 12, wherein funds associated with the pending transaction are not available for further transactions until the one or more computing devices receives the transaction request from the user computing device.
